(19) United States
(12) Patent Application Publication
(10) Pub. No.: US 2026/0222881 A1
(43) Pub. Date: Jul. 30, 2026

(54) JOINT AND SEPARATE CSI PREDICTION BASED ON AI/ML CSI COMPRESSION

(71) Applicant: Samsung Electronics Co., Ltd., Suwon-si (KR)

(72) Inventors: Hamid SABER, San Diego, CA (US); Jung Hyun BAE, San Diego, CA (US)

(21) Appl. No.: 19/448,097

(22) Filed: Jan. 13, 2026

Related U.S. Application Data
(60) Provisional application No. 63/750,260, filed on Jan. 27, 2025.

(51) Int. Cl. H04W 24/10

(52) U.S. Cl. CPC H04W 24/10

(57) ABSTRACT

Systems, methods, and apparatuses are disclosed for joint and separate CSI prediction based on AI/ML CSI compression. In one or more examples, the systems, devices, and methods include measuring at least one downlink reference signal (RS) over an observation window comprising a plurality of slots and sub-bands, generating, using a CSI prediction model at a UE, predicted CSI for a prediction window with one or more future slots based at least on the measured CSI from the observation window, where the UE is configured to refrain from transmitting the predicted CSI to a base station. The systems, devices, and methods also include generating, using a CSI encoder at the UE, CSI feedback that jointly represents target CSI across time, space, and frequency for observation and prediction slots and transmitting the CSI feedback to the base station.

### CROSS-REFERENCE TO RELATED APPLICATIONS

This application claims the benefit of U.S. Provisional Patent Application Ser. No. 63/750,260, filed Jan. 27, 2025, which is incorporated by reference herein for all purposes.

### TECHNICAL FIELD

The disclosure relates generally to memory systems. In particular, the subject matter relates to joint and separate channel state information (CSI) prediction based on artificial intelligence/machine learning (AI/ML) CSI compression.

### SUMMARY

The present background section is intended to provide context only, and the disclosure of any concept in this section does not constitute an admission that said concept is prior art.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system, or a New Radio (NR) system). A wireless multiple-access communications system may include a number of base stations or access network nodes, each simultaneously supporting communication for multiple communication devices, which may be otherwise known as user equipment (UE). A base station may provide multiple UEs access to certain network services such as transmission of voice and data communications.

In some cases, CSI feedback can lack a standardized way to exploit temporal correlation, coordinate multi-model AI inference, and manage the added compute of prediction at the UE, resulting in excessive uplink payload, ambiguous mappings across time/frequency, and poor interoperability. There is no mechanism to link a prediction stage to compression without redundant reporting, no clear input/output ordering to avoid payload-size ambiguity, and no lifecycle management or mechanisms to monitor AI models. Training data collection can be costly in overhead of channel state information reference signal (CSI-RS) and/or yield low-fidelity labels, and vendors can face relatively heavy bilateral coordination because reference scope, parameter/dataset exchange, and decoder assumptions can be undefined. Legacy CPU accounting ignores AI inference costs, leading to resource overrun and unpredictable collision handling. The systems and methods described herein solve these problems by defining separate prediction and compression/joint prediction and compression (SPC/JPC) control via one or linked report configurations, deterministic time, space, and frequency (TSF) mappings, dual training modes balancing overhead and label quality, standardized inter-vendor collaboration covering prediction and encoder models, and explicit CPU/APU counting and occupation windows for prediction-only configurations.

The systems and methods described herein provides a standards-ready framework for AI/ML-based CSI feedback that integrates time-space-frequency compression with explicit support for predictive operation, enabling a UE to predict future-slot CSI and then compress observed and predicted CSI for efficient uplink reporting while the base station (e.g., the base station, the base station) reconstructs target CSI via a decoder. The disclosure introduces two inference modes: separate prediction and compression (SPC) using two linked CSI configurations (e.g., CSI-ReportConfigs) or a single configuration. A single configuration can also signal joint prediction and compression (JPC), and define deterministic input/output mappings across sub-bands and slots to ensure unambiguous encoding/decoding. The disclosure further specifies training data collection modes that trade CSI-RS overhead against label fidelity, inter-vendor collaboration mechanisms (reference models/structures, parameter or dataset exchange) that cover both prediction models and encoder models, and explicit CPU/APU accounting and occupation-window reuse so prediction-only configurations are counted toward UE processing budgets. Together these elements increase feedback efficiency, reduce uplink payload, maintain channel quality indicator/rank indicator (CQI/RI) dependency consistency, enable lifecycle management and performance monitoring, and ensure multi-vendor interoperability for predictive TSF-domain CSI compression.

In various embodiments, the systems and methods described herein include systems, methods, and apparatuses for joint and separate CSI prediction based on AI/ML CSI compression. In some aspects, ... In some aspects, the techniques described herein relate to a method performed by a user equipment (UE) for artificial intelligence/machine learning (AI/ML) based channel state information (CSI) compression, including: measuring at least one downlink reference signal (RS) over an observation window including a plurality of slots and sub-bands; generating, using a CSI prediction model at the UE, predicted CSI for a prediction window including one or more future slots based at least on the measured CSI from the observation window, the UE being configured to refrain from transmitting the predicted CSI to a base station; generating, using a CSI encoder at the UE, CSI feedback that jointly represents target CSI across time, space, and frequency for observation and prediction slots; and transmitting the CSI feedback to the base station.

In some aspects, the techniques described herein relate to a method, wherein the UE being configured to refrain from transmitting the predicted CSI is based on: receiving, by the UE, a first CSI configuration identifying the prediction window and a second CSI configuration identifying a compression window, wherein: at least one of the first CSI configuration or the second CSI configuration has a report quantity field set to none to indicate refraining from reporting the predicted CSI, and the UE uses output of the CSI prediction model as input to the CSI encoder without reporting the predicted CSI to the base station.

In some aspects, the techniques described herein relate to a method, wherein the UE being configured to refrain from transmitting the predicted CSI is based on: receiving, from the base station, an information element that indicates a first CSI configuration associated with prediction is linked to a second CSI configuration associated with compression, wherein the information element is included in the first CSI configuration, the second CSI configuration, or both.

In some aspects, the techniques described herein relate to a method, further including: collecting training data for the CSI encoder under a first mode in which CSI-RS for the observation window is received from the base station; measuring target CSI for observed slots based on the CSI-RS transmitted for the observation window and not the prediction window; obtaining, based at least in the measuring, labels for prediction slots from outputs of the CSI prediction model; and training, based at least on the obtaining, the CSI encoder to minimize reconstruction error over target CSI spanning the observation and prediction slots.

In some aspects, the techniques described herein relate to a method, further including: collecting training data for the CSI encoder under a second mode, wherein CSI-RS for both the observation window and the prediction window is received from the base station under the second mode; measuring target CSI for the observation and prediction slots; and training, based at least on the measuring, the CSI encoder to minimize reconstruction error over measured target CSI spanning the observation and prediction slots.

In some aspects, the techniques described herein relate to a method, further including receiving, from the base station, inter-vendor collaboration information including at least one of: model parameters for the CSI prediction model and the CSI encoder model, standardized model structures corresponding to the CSI prediction model and the CSI encoder, the standardized model including at least one of model version, number of layers, number of neurons, or weight values, the CSI prediction model and the CSI encoder transmitted from the base station to the UE, or a dataset including paired inputs and outputs for the CSI prediction model and paired inputs and outputs for the CSI encoder with defined time, space, frequency (TSF) mapping and quantization.

In some aspects, the techniques described herein relate to a method, further including counting, by the UE, processing resources for the predicted CSI, including: occupying a number of CSI processing units (CPUs), for executing the CSI prediction model for the predicted CSI; occupying a number of AI/ML processing units (APUs) for prediction model inference performed to determine the predicted CSI; and applying occupation window rules for a first CSI configuration that reuses occupation windows determined to be applicable to a second CSI configuration.

In some aspects, the techniques described herein relate to a method, further including: reporting, by the UE, capability information indicative of a maximum number of CPUs and APUs available for simultaneous CSI processing, including a dedicated capability value for prediction-only configurations linked to compression, and declining to update one or more CSI reports when configured reports exceed the reported capability.

In some aspects, the techniques described herein relate to a method, further including: receiving, by the UE, a CSI configuration that indicates separate prediction and compression (SPC) and specifies an observation window and a prediction window; performing SPC according to an indicator in the CSI configuration; and including information in the CSI feedback for a decoder of the base station to reconstruct target CSI corresponding to the prediction window.

In some aspects, the techniques described herein relate to a method, further including: reporting, by the UE, metrics for performance monitoring linked to a single CSI configuration, the metrics including a prediction metric indicative of prediction accuracy across one or more configured time instances and a compression metric indicative of reconstruction quality across one or more configured time instances, wherein the metrics are computed according to a decoder shared by the base station, a reference decoder, or a proxy decoder at the UE.

In some aspects, the techniques described herein relate to a method performed by performed a base station for artificial intelligence/machine learning (AI/ML) based channel state information (CSI) compression, including: configuring a user equipment (UE) with an observation window including a plurality of slots and sub-bands and with a prediction window including one or more future slots; transmitting at least one downlink reference signal (RS) over the observation window including the plurality of slots and sub-bands; configuring the UE to use a CSI prediction model to generate predicted CSI based at least on measured CSI from the observation window and to refrain from reporting the predicted CSI; receiving, from a CSI encoder at the UE, CSI feedback that jointly represents target CSI across time, space, and frequency for observation and prediction slots; and reconstructing, by a decoder at the base station, target CSI for at least the observation and prediction slots based on the received CSI feedback.

In some aspects, the techniques described herein relate to a method, wherein configuring the UE to refrain from reporting the predicted CSI is based on: transmitting, to the UE, a first CSI configuration identifying the prediction window and a second CSI configuration identifying a compression window, wherein: at least one of the first CSI configuration or the second CSI configuration has a report quantity field set to none to indicate reporting the predicted CSI is to be refrained, and the report quantity field set to none indicates to the UE to use output of the CSI prediction model as input to the CSI encoder without reporting the predicted CSI to the base station.

In some aspects, the techniques described herein relate to a method, wherein configuring the UE to refrain from reporting the predicted CSI is based on: receiving, from the base station to indicate separate prediction and compression, an information element that indicates a first CSI configuration associated with prediction is linked to a second CSI configuration associated with compression, wherein the information element is included in the first CSI configuration, the second CSI configuration, or both.

In some aspects, the techniques described herein relate to a method, further including: collecting training data for the decoder under a first mode in which the base station transmits, to the UE, CSI-RS for the observation window and the base station refrains from transmitting CSI-RS for the prediction window; transmitting, to the UE, labels for prediction slots based on outputs of the CSI prediction model; and training, based at least on the training data, the decoder to minimize reconstruction error over target CSI spanning the observation and prediction slots.

In some aspects, the techniques described herein relate to a method, further including: collecting training data for the decoder under a second mode in which the base station transmits, to the UE, both the observation window and the prediction window; and training, based at least on the training data, the decoder to minimize reconstruction error over measured target CSI spanning the observation and prediction slots.

In some aspects, the techniques described herein relate to a method, further including transmitting, to the UE, inter-vendor collaboration information including at least one of: model parameters for the CSI prediction model and the CSI encoder model, standardized model structures corresponding to the CSI prediction model and the CSI encoder, the standardized model including at least one of model version, number of layers, number of neurons, or weight values, the CSI prediction model and the CSI encoder transmitted from the base station to the UE, or a dataset including paired inputs and outputs for the CSI prediction model and paired inputs and outputs for the CSI encoder with defined time, space, frequency (TSF) mapping and quantization.

In some aspects, the techniques described herein relate to a method, further including: obtaining, from the UE, capability information indicative of a maximum number of CSI processing units (CPUs) and AI/ML processing units (APUs) available for simultaneous CSI processing, the capability information including a dedicated capability value for prediction-only configurations linked to compression; and scheduling CSI reporting such that configured reports do not exceed the reported capability.

In some aspects, the techniques described herein relate to a non-transitory computer-readable medium storing code for artificial intelligence/machine learning (AI/ML) based channel state information (CSI) compression, the computer-readable medium including instructions executable by one or more processors of a user equipment (UE) to: measure at least one downlink reference signal (RS) over an observation window including a plurality of slots and sub-bands; generate, using a CSI prediction model at the UE, predicted CSI for a prediction window including one or more future slots based at least on the measured CSI from the observation window, the UE being configured to refrain from transmitting the predicted CSI to a base station; generate, using a CSI encoder at the UE, CSI feedback that jointly represents target CSI across time, space, and frequency for observation and prediction slots; and transmit the CSI feedback to the base station.

In some aspects, the techniques described herein relate to a non-transitory computer-readable medium, wherein: the UE being configured to refrain from transmitting the predicted CSI is based on the UE receiving, from the base station, a first CSI configuration identifying the prediction window and a second CSI configuration identifying a compression window, at least one of the first CSI configuration or the second CSI configuration has a report quantity field set to none to indicate the refraining from reporting the predicted CSI, and the UE uses output of the CSI prediction model as input to the CSI encoder without reporting the predicted CSI to the base station.

In some aspects, the techniques described herein relate to a non-transitory computer-readable medium, wherein: the UE being configured to refrain from transmitting the predicted CSI is based on the UE receiving, from the base station, an information element that indicates a first CSI configuration associated with prediction is linked to a second CSI configuration associated with compression, and the information element is included in the first CSI configuration, the second CSI configuration, or both.

The systems and methods described herein include multiple advantages and benefits. For example, the systems and methods described herein deliver substantial gains by orchestrating AI/ML-based CSI prediction and compression across time, space, and frequency with clear network signaling and resource accounting, yielding higher feedback efficiency, reduced uplink payload, and improved reconstruction accuracy for both present and future slots. Separating prediction from compression enables flexible lifecycle management, targeted training, and vendor interoperability, while linked or single configuration control minimizes signaling overhead and eliminates redundant intermediate reports. Deterministic input/output mappings avoid payload ambiguity and ensure robust multi-vendor operability, and the dual training modes optimize CSI-RS overhead by aligning label quality with prediction confidence. Explicit CPU/APU counting for prediction-only configurations protects UE complexity, preserves collision handling, and supports scalable deployment. Finally, the framework's performance monitoring hooks and standardized model/parameter/dataset exchanges accelerate field adaptation, mitigate data distribution mismatch, and provide a practical path to standardization-ready TSF-domain CSI compression with predictive capability.

### BRIEF DESCRIPTION OF THE DRAWINGS

In the following section, the aspects of the subject matter disclosed herein will be described with reference to exemplary embodiments illustrated in the figures, in which:

These and other features and advantages of the present disclosure will be appreciated and understood with reference to the specification, claims, and appended drawings, wherein:

FIG. 1 illustrates an example system in accordance with one or more implementations as described herein.

FIG. 2 illustrates an example system in accordance with one or more implementations as described herein.

FIG. 3 illustrates an example diagram in accordance with one or more implementations as described herein.

FIG. 4 illustrates an example system in accordance with one or more implementations as described herein.

FIG. 5 depicts a flow diagram illustrating an example method associated with the disclosed systems, in accordance with example implementations described herein.

FIG. 6 depicts a block diagram of an electronic device in a network environment, in accordance with example implementations described herein.

FIG. 7 illustrates an example of a system in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not to obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms, and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

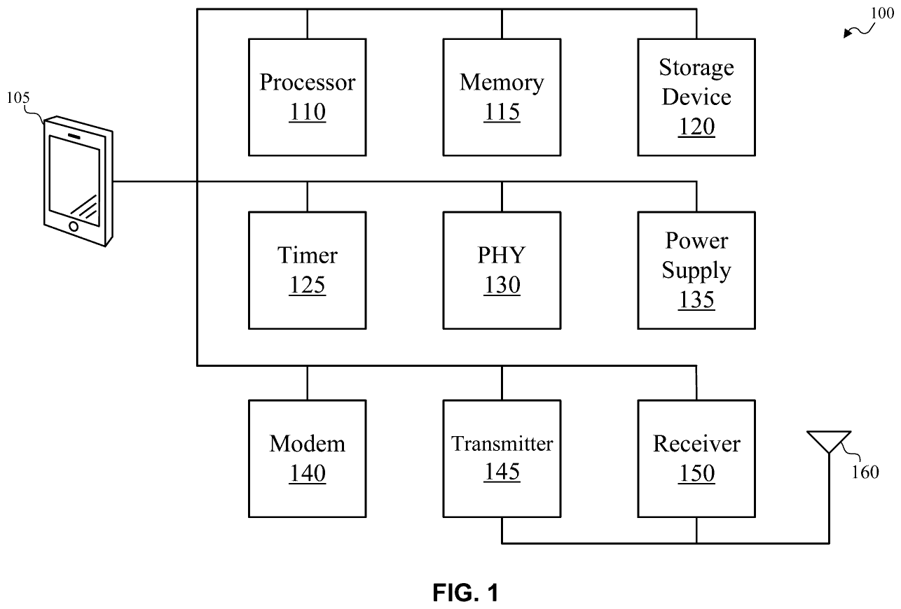

FIG. 1 illustrates an example of a system 100, of a wireless communications network, that supports joint and separate CSI prediction based on AI/ML CSI compression with example implementations described herein.

As shown, system 100 may include device 105. Device 105 may include a mobile device, a cellphone, a smartphone, a tablet, a laptop, a wearable computing device, an Internet-of-things device, a user equipment (UE), a vehicle (e.g., autonomous vehicle), any device configured to transmit and/or receive a wireless signal, or any wireless/wired network-connected device. As shown, device 105 may include a processor 110, a memory 115, a storage device 120, a timer 125, a physical layer (PHY) 130, a power supply 135, a modem 140, at least one transceiver (e.g., transmitter 145, receiver 150), and at least one antenna (e.g., antenna 160). Device 105 may communicate with one or more devices via at least antenna 160 and at least one network (e.g., short-range wireless communication network, long-range wireless communication network).

In some cases, device 105 may include an input device, a sound output device, a display device, an audio module, a sensor module, an interface, a haptic module, a camera module, a communication module, a subscriber identification module (SIM) card, or an antenna module. In one embodiment, at least one component (e.g., display device, camera module) may be omitted from device 105, or one or more other components may be added to device 105. Some of the components may be implemented as a single integrated circuit (IC). For example, a sensor module (e.g., a fingerprint sensor, an iris sensor, or an illuminance sensor) may be embedded in a display of device 105.

In some cases, processor 110 may execute software (e.g., a program) to control at least one other component (e.g., a hardware, a software component, etc.) of device 105 coupled with processor 110. Processor 110 may perform various data processing or computations. For example, processor 110 may measures downlink reference signals across configured sub-bands and slots within an observation window, execute a CSI prediction model to generate predicted CSI for a configured prediction window of future slots, suppress standalone reporting of the prediction results when indicated, form a deterministic time-space-frequency ordered representation by vectorizing per-sub-band, per-slot CSI matrices and concatenating them across sub-bands and slots, apply a CSI encoder model to jointly compress the observed and predicted CSI into a CSI feedback payload, and transmit the payload to a base station for reconstruction by a decoder. In some cases, processor 110 may interpret one or more CSI-ReportConfigs that signal separate prediction and compression or joint prediction and compression, enforce linked-configuration behavior (e.g., including “reportQuantity=none” for prediction) and model/pairing identifiers, compute and report CQI/RI consistently with the precoder implied by the encoder/decoder pairing, accounts for and manages local processing resources by allocating CPUs and AI/ML processing units and applying legacy occupation-window rules to prediction-only configurations, optionally collects and curates training data under configurable modes that trade CSI-RS overhead for label fidelity, performs offline engineering using received model parameters or datasets to adapt or validate UE-side models, and reports configured performance metrics to enable lifecycle management of the prediction and compression functions.

As at least part of the data processing or computations, processor 110 may load a command or data received from another component (e.g., receiver 150, etc.) in memory 115, process the command or the data stored in memory 115, and store resulting data in storage device 120. In some cases, processor 110 may include a main processor (e.g., a central processing unit (CPU) or an application processor (AP)), and an auxiliary processor (e.g., a graphics processing unit (GPU), an image signal processor (ISP), a sensor hub processor, and/or a communication processor (CP)) that is operable independently from, or in conjunction with, the main processor. Additionally, or alternatively, the auxiliary processor may be adapted to consume less power than the main processor, or execute a particular function. The auxiliary processor may be implemented as being separate from, or a part of, the main processor.

In some examples, memory 115 may store various data used by at least one component (e.g., processor 110, etc.) of device 105. The various data may include, for example, software (e.g., a program, application) and input data or output data for a command related thereto. In some cases, memory 115 may include volatile memory (e.g., random-access memory (RAM) dynamic RAM (DRAM), static RAM (SRAM)) and/or non-volatile memory (e.g., NAND flash memory). In some cases, memory 115 and/or storage device 120 may include internal memory and/or external memory. One or more programs may be stored in the memory 115 as software, and may include, for example, an operating system (OS), middleware, and/or an application.

In some cases, timer 125 may be configured to time one or more operations, indicate or measure a time period, indicate a lapse of time, indicate an expiration, indicate a timeout, etc. In some cases, timer 125 may be configured to indicate a lapse of time, indicate an expiration, and/or indicate a timeout in relation to one or more components of device 105. For example, timer 125 may be configured to indicate a lapse of time and/or provide a clock cycle in relation to an operation of one or more components of device 105.

In some examples, PHY 130 may include an electronic circuit configured to implement physical layer functions of the open systems interconnection (OSI) model (e.g., in conjunction with a network interface controller of device 105). PHY 130 may connect a link layer device (e.g., medium access control (MAC) to a physical medium of device 105 (e.g., radio waves, electromagnetic radiation, radiofrequency (RF) energy).

In some examples, power supply 135 (e.g., a battery, a power adapter, power management module, etc.) may supply power to at least one component of device 105. In some examples, power supply 135 may include, for example, a cell (e.g., primary cell) that is not rechargeable, a cell (e.g., secondary cell) that is rechargeable, a fuel cell, etc.

A communication module of device 105 may support establishing a direct (e.g., wired) communication channel and/or a wireless communication channel between device 105 and at least one external electronic device and performing communication via the established communication channel. The communication module may include one or more communication processors that are operable independently from processor 110 and may support a direct (e.g., wired) communication and/or a wireless communication. The communication module may include a wireless communication module (e.g., a cellular communication module, a short-range wireless communication module, transmitter 145, receiver 150, antenna 160, etc.) or a wired communication module (e.g., a local area network (LAN) communication module, a power line communication (PLC) module, etc.). A corresponding one of these communication modules may communicate with the external electronic device via at least a first network (e.g., a short-range communication network, such as BLUETOOTH®, wireless-fidelity (Wi-Fi) direct, a standard of the Infrared Data Association (IrDA)) or a second network (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module may identify and/or may authenticate device 105 in a communication network using subscriber information (e.g., international mobile subscriber identity (IMSI)) stored in the subscriber identification module.

In some examples, antenna 160 (e.g., of transmitter 145 and/or receiver 150) may transmit a signal (e.g., RF energy) to and/or receive a signal from or one or more devices external to device 105. Antenna 160 may include one or more antennas. For example, antenna 160 may include at least one antenna appropriate for a communication scheme used in the communication network. A signal or power received by antenna 160 may be received by receiver 150 of device 105, and/or a signal or power transmitted by antenna 160 may be generated by transmitter 145.

Commands or data may be transmitted or received between device 105 and an external electronic device via a server coupled to at least one network. All or some of the operations executed at device 105 may be executed at one or more external electronic devices. For example, if device 105 performs a function or a service automatically, or in response to a request from a user or another device, device 105, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to device 105. The device 105 may provide the outcome, with or without further processing of the outcome, as at least part of a reply to the request. To that end, a cloud computing, distributed computing, or client-server computing technology may be used, for example.

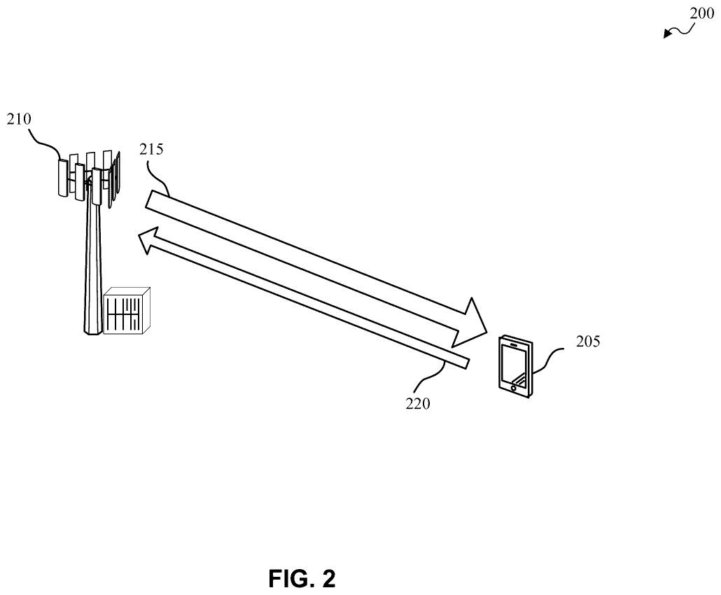

FIG. 2 illustrates an example of a system 200, of a wireless communications network, that supports increasing reliability in responding to request capability messages in relation to E911 control plane calls with example implementations described herein.

As illustrated, wireless communications system 200 may include device 205 and base station 210. Base station 210 may connect device 205 to a core network (e.g., a central, high-speed backbone of a telecommunications network, responsible for routing data and connecting different parts of the network). Device 205 may be an example of device 105, as described above with reference to FIG. 1. Wireless communications system 200 may also include downlink 215 and uplink 220. Base station 210 may use downlink 215 to convey control and/or data information to device 205. And device 205 may use uplink 220 to convey control and/or data information to base station 210. In some cases, downlink 215 may use different time and/or frequency resources than uplink 220. In some cases, base station 210 may be associated with a geographic coverage area in which communications with one or more UEs (e.g., device 205) is supported.

Device 205 may receive one or more transmissions from base station 210. In some cases, the one or more transmissions may include a configuration or an indication of a configuration for device 205 (e.g., to enable a timer, such as timer 125, in relation to requests for location information, such as capability request messages). In some cases, device 205 may receive the configuration in a radio resource control message or a media access control (MAC) control element (MAC-CE) message, or both.

In some examples, the one or more transmissions may include a capability request message. In some cases, the capability request message may include a UE capability enquiry message configured to enable base station 210 to discover the supported features and functionalities of device 205 for optimal network resource allocation and communication. When a network updates its knowledge of the capabilities of a UE (e.g., device 105), the MME of a core network may initiate a capability request message (e.g., the capability request message of downlink 215). In some examples, the MME may trigger base station 210 to send the capability request message to device 105 (e.g., via the radio resource control (RRC) layer).

Upon receiving the capability request message, device 105 may respond with a capability request response (e.g., the capability request response of uplink 220) containing supported features, functionalities, etc., of device 105. As shown, the capability request response may be sent back to base station 210, and base station 210 may relay this information to the MME. The network may use the capability information of device 105 to tailor its communication with device 105, ensuring optimal performance and resource utilization. For example, the network can choose the appropriate frequency bands, modulation schemes, and other parameters based on the capabilities of device 105.

Accordingly, a network may send a UE Capability Enquiry message (e.g., the capability request message of downlink 215) to gather information about a UE's capabilities (e.g., capabilities of device 205), enabling the network to optimize its communication with the UE and ensure efficient resource allocation. The network may request the UE's capabilities, including location-related ones, to properly configure the UE and provide the appropriate services, including location-based services.

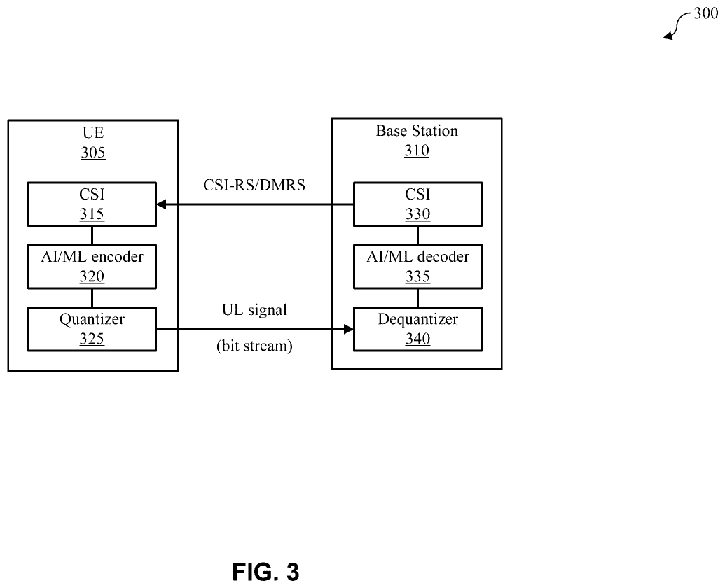

FIG. 3 illustrates an example of a system 300, of a wireless communications network, that supports joint and separate CSI prediction based on AI/ML CSI compression based on example implementations described herein.

In the illustrated example, system 300 may include UE 305 and base station 310, which may be respective examples of device 205 and base station 210. As shown, UE 305 may include CSI 315, AI/ML encoder 320, and quantizer 325. Base station 310 may include CSI 330, AI/ML decoder 335, and dequantizer 340.

AI/ML encoder 320 may include a user-equipment resident neural network component configured to compress channel state information across time, space, and frequency into a compact feedback representation suitable for uplink transmission. AI/ML encoder 320 may receive, as input features, CSI derived from CSI-RS bursts over a configured observation window, which may include measured CSI for observed slots and, in separate prediction and compression operation, predicted CSI for future slots produced by a UE-side prediction model. The inputs may be deterministically arranged by vectorizing per-sub-band, per-slot matrices and concatenating them across sub-bands and slots according to a predefined ordering. AI/ML encoder 320 may processes an ordered tensor through a learned network backbone, such as a convolutional, transformer, or multilayer perceptron architecture matched to a standardized structure, to exploit spatial, frequency, and temporal correlations and to project the high-dimensional CSI into a low-dimensional latent vector that constitutes the CSI feedback payload after quantization. During inference, AI/ML encoder 320 may operate under control of one or more CSI-ReportConfigs that specify the observation and prediction windows and indicate whether operation is separate prediction and compression or joint prediction and compression, and may refrain from emitting intermediate prediction outputs when the linked prediction configuration has reportQuantity set to none. AI/ML encoder 320 may be trained, alone or jointly, with a network-side decoder, using datasets curated under modes that either assume ideal prediction labels for future slots or collect measured labels for both observed and predicted slots, with a loss objective that minimizes reconstruction error at the decoder output. By concentrating the informative content of multi-slot, multi-sub-band CSI into a relatively small, deterministic bitstream, AI/ML encoder 320 reduces uplink payload while preserving reconstruction fidelity at the base station and supports lifecycle management, inter-vendor interoperability, and resource accounting through explicit model identifiers and processing-unit usage.

Using AI/ML models allows the compression of CSI information into a reasonable number of bits. As shown, one or more reference signals (e.g., CSI-RS, demodulation reference signal (DMRS), etc.) may be communicated from CSI 330 to CSI 315 via a downlink (DL) signal. UE 305 may compute predicted CSI based on the reference signals and AI/ML encoder 320 may compress the predicted CSI. For example, UE 305 may use DL RS transmissions (e.g., CSI-RS, DMRS) to extract the CSI, which is then encoded via AI/ML encoder 320 into a feature vector. Quantizer 325 may quantize (e.g., generate a stream of bits) from the compressed data, and UE 305 may transmit the stream of bits via an uplink (UL) signal to the base station 310. For example, the feature vector may be quantized by quantizer 325 into a stream of bits, which is transmitted to base station 310.

As shown, dequantizer 340 of base station 310 may receive the stream of bits and dequantize the stream of bits (e.g., form the compressed data from the stream of bits), and AI/ML decoder 335 may decode the compressed data, and CSI 330 may analyze the CSI measurements. For example, dequantizer 340 may use the stream of bits to reconstruct the feature vector, which may be fed into AI/ML decoder 335 to produce an estimate of the CSI.

Training data may be used to train CSI prediction, CSI encoding, quantizing, dequantizing, etc., to perform CSI computation at UE 305 and base station 310 with sufficient accuracy (e.g., satisfying respective model accuracy thresholds).

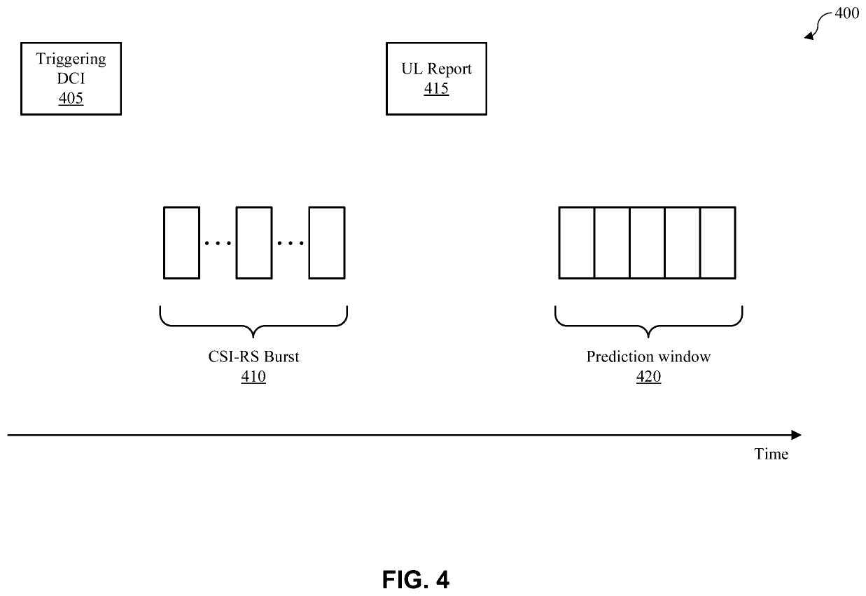

FIG. 4 illustrates an example of a diagram 400, of a wireless communications network, that supports joint and separate CSI prediction based on AI/ML CSI compression based on example implementations described herein.

As shown, diagram 400 depicts triggering downlink control information (DCI) 405, CSI-RS burst 410, uplink (UL) report 415, and compression window 420 (e.g., a compression window, a prediction/compression window) in relation to the flow of time from left to right. In some examples, aspects of diagram 400 may be based on having time domain, spatial and frequency domain compression, as well as separate prediction and compression.

Diagram 400 illustrates a timeline for separate prediction and compression. At the left, triggering DCI 405 activates the configured CSI procedures and defines the observation and prediction windows. Following this trigger, a UE (e.g., device 205) receives and measures one or more CSI-RS bursts (e.g., CSI-RS burst 410), which the UE may receive from a base station (e.g., base station 210).

As shown, CSI-RS burst 410 may be received over multiple slots (e.g., over m consecutive or configured slots). As shown, CSI-RS burst 410 may include CSI-RS over the indicated time instances and sub-bands (e.g., frequency in vertical direction), where CSI-RS burst 410 produces observed CSI over the indicated time instances and sub-bands. These measurements occupy CSI processing unit (CPU) resources of the UE. When AI/ML inference is involved, the measurements occupy AI/ML processing unit (APU) resources as well.

Using the observed CSI, the UE may run a CSI prediction model to generate predicted CSI for future slots defined by prediction window 420. In some cases, the UE may not report the prediction output standalone when the linked configuration specifies reportQuantity=none.

In some cases, the UE may generate CSI feedback based on CSI-RS burst 410. In some cases, the UE generating the CSI feedback may include the UE forming a deterministic time, space, frequency (TSF) ordered representation of the observed and predicted CSI. Additionally, the UE generating the CSI feedback may include the UE compressing the TSF ordered representation (e.g., via a UE-side CSI encoder). As shown, the UE may transmit the resulting CSI feedback in an uplink report (e.g., UL report 415). The UE may transmit UL report 415 via physical uplink control channel (PUCCH).

At the base station, a decoder of the base station may reconstruct the target CSI corresponding to prediction window 420 (e.g., and, as applicable, the observed slots), enabling the base station to utilize CSI for both present and upcoming slots while the UE's prediction stage remains transparent in terms of reporting, but is accounted for in processing resources.

When the UE has a first model (e.g., AI/ML model) that does the prediction and a second model (e.g., second AI/ML model) that does the compression, the base station may activate the CSI compression CSI report configuration.

In some cases, separate prediction and compression may be based on a single CSI report configuration. Alternatively, prediction and compression may be based on two CSI report configurations. With a single CSI report configuration, the base station activates a CSI report configuration with the properties of the observation window and the prediction window (e.g., prediction window 420). The UE may then determine that the CSI that is reporting corresponds to which slots of prediction window 420. In some cases, one CSI report configuration may be configured to the UE and activated to UE, and the UE determines which slots to report the CSI for.

In some cases, the CSI report configuration can indicate to the UE a joint prediction and compression explicitly or implicitly. For example, the UE can determine when input to the model does not correspond to the same prediction window, and then the UE determines to perform prediction. For example, the base station may configure the CSI report configuration, and the UE performs the prediction (e.g., as determined by the UE, as needed, etc.), and then the UE does the compression jointly across different time domains.

Alternatively, the base station can configure two different CSI reports. The base station may configure one CSI report for CSI compression and configure another CSI report for CSI prediction. Accordingly, the base station may configure a CSI prediction configuration for the UE, where the configuration involves the UE measuring the CSI in a number of slots of an observation window (e.g., two slots, slot H1 and slot H2). In some cases, the CSI prediction may be reported in a prediction window (e.g., prediction window 420) in relation to some number of slots of the prediction window (e.g., four slots, five slots, etc.). In some cases, this prediction window may at least partially overlap with the observation window. For example, the first slot (e.g., at least a portion of the first slot), or the first slot and at least a portion of the second slot, etc., may overlap with the observation window.

The observation window may include a UE-configured time span, defined by the network via CSI-ReportConfig and may be triggered by a DCI, during which the UE receives CSI-RS bursts over m slots and measures the downlink channel across configured sub-bands and antenna ports. These per-slot, per-sub-band CSI matrices form the “observed” inputs for the AI/ML pipeline. In separate prediction and compression, they may be fed to a UE-side prediction model to extrapolate CSI for future target slots, and then the observed and predicted CSI may be arranged (e.g., vectorized and concatenated across sub-bands and slots) and compressed by an encoder (e.g., AI/ML encoder 320) into a CSI feedback payload. Thus, the observation window can anchor the temporal reference for measurement, govern CPU/APU occupation (from trigger to UL report), and set the correlation context for the encoder. The size and placement of the observation window relative to a subsequent prediction window may be signaled so that the base station can reconstruct target CSI for the intended slots using the paired decoder.

The base station may then configure a second CSI report configuration for CSI compression, where the base station configures to compress CSI in a number of slots (e.g., over four slots H1 to H4). The UE may then predict CSI, compress the CSI in the number of slots, and then report the compressed CSI to the base station. The base station may then use a CSI decoder to construct slots H1 to H4.

In some cases, for separate prediction/compression, the base station may link the two CSI report configurations together (e.g., link CSI reports for prediction and compression by ID). In some cases, an information element (IE) from the base station may indicate that, although there is a prediction report, the IE may instruct the UE not to transmit the prediction report. Unlike other systems, this CSI prediction report configuration does not include the UE reporting CSI prediction, but the UE may apply it. For example, the CSI prediction model may obtain the prediction values and then feed the prediction values to the CSI compression model. The UE may then report based on the CSI compression model. Thus, the UE may be configured where the output of the model that predicts the CSI is not reported to the base station, but this prediction output is used as an input to the encoder of the CSI compression. Accordingly, the UE does not report for and report CSI of the output of the model for a first CSI report configuration, which is a prediction window prediction report.

In some cases, the base station may activate a CSI prediction configuration via a CSI-ReportConfig, which may include the time domain properties of the prediction window among other information. As explained, the UE does not report CSI for this ReportConfig, which is indicated to the UE by the base station.

In some cases, the base station may use ReportQuality to indicate the UE does not report CSI for a given ReportConfig. For example, the report quantity of a CSI-ReportConfig corresponding to the CSI prediction may be set to “None.” In some cases, one or more other IEs may be included to indicate that this CSI-ReportConfig is not a standalone CSI-ReportConfig and that the prediction results are not reported to the base station.

Additionally, or alternatively, the base station may link the CSI configurations by ID. For example, the base station may link a CSI prediction report configuration CSI-ReportConfig with ID #1 to a CSI compression report configuration CSI-ReportConfig with ID #2. The linkage may be indicated by an IE in one report configuration (e.g., prediction report configuration or compression report configuration) or both of the report configurations.

In some cases, the base station may activate separate prediction CSI-ReportConfig to allow the base station to perform management operations, such as performing monitoring, etc. In some cases, the base station may separately configure/activate a prediction report and/or a monitoring report based on separate prediction CSI-ReportConfig.

In some cases, the base station may activate a CSI compression configuration via a CSI-ReportConfig that includes the time domain properties of the prediction window among other information, such as model configuration, pairing ID, etc. As stated, the base station may indicate to the UE via an IE whether the configuration is for SPC or JPC. As explained, in case of SPC, the base station may link CSI-prediction performance monitoring to the compression CSI-ReportConfig, so that the UE reports the KPI for the prediction model performance, e.g., SGCS for some configured prediction instances. In some cases, the base station may also link a CSI-compression performance monitoring to the compression CSI-ReportConfig. UE reports the key performance indicator (KPI) for one or more time instances, based on a reconstructed CSI using a reference decoder or proxy decoder at the UE side.

The systems and methods described herein may include training data collection. In some cases, the base station may configure a CSI-ReportConfig for training data collection of the prediction model. In some cases, the CSI-ReportConfig for training data collection may be provided separately from other CSI-ReportConfigs from the base station. For training a CSI compression model, the base station may instruct the UE on how to perform signal strength and quality measurements over a specified number of time slots. For example, the base station may configure a reference signal for Nₘ measured slots. The labels (e.g., ground-truth (GT) CSI) may be used for a number of prediction slots (e.g., Nₚ prediction slots). The labels, or GT CSI, may represent actual, measured, and/or verified accurate CSI for a time slot specified by the base station.

When the performance of the CSI prediction model is relatively ensured based on previous training (e.g., the CSI prediction model satisfies an accuracy threshold), CSI-RS overhead may be reduced by transmitting M RSs in the CSI-ReportConfigs for training, where M is some positive integer (e.g., 1, 8, 16, 32, etc.). For example, the base station may transmit M CSI-RSs for training data collection, where the labels are obtained by the output of the prediction model at P slots, where P is some positive integer (e.g., 1, 8, 16, 32, etc.).

When the performance of the CSI prediction model is not ensured (e.g., the CSI prediction fails to satisfy the accuracy threshold), its prediction error may be considered for training of the compression model. In this case, the base station may transmit more than M CSI-RSs (e.g., M+P CSI-RSs) for training the compression model. For example, the base station may transmit M+P CSI-RSs for training data collection, where the labels are obtained as measured CSI in P prediction slots.

Training data may be collected and analyzed for separate prediction and compression (SPC) implementations. With some operations, the UE may measure the CSI in M slots, feed the measured CSI to the prediction model, and then output the predicted CSI. In this case, the predicted CSI may be for P prediction slots. Accordingly, the output of the decoder (e.g., reconstructed CSI) may correspond to slot 1 through slot P.

In some cases, when training the prediction model, the CSI prediction model may be assumed to be ideal. Thus, when M slots are measured, the base station does not transmit (e.g., does not need to transmit) the other slots that the prediction model predicts. In some cases, the base station may only transmit M CSI-RSs, and the labels that the UE uses for training the encoder and decoder may be from the output of the prediction model. Accordingly, the base station may transmit CSI-RSs in the first observation window (e.g., only in the first observation window), or the M slots that the UE measures. The first observation window may not include every slot from which the UE compresses CSI. In some cases, there may be P slots for compression and M slots for observation (e.g., where M is less than P).

Accordingly, in a first SPC mode, the base station may transmit M CSI-RSs based on a relatively accurate prediction model (e.g., satisfies a model threshold). In a second SPC mode, the base station may transmit M+P CSI-RSs because the CSI prediction model is determined not to be ideal (e.g., fails to satisfy a model threshold). In the second mode, the label for every slot associated with the compression window may be used, the base station transmitting M CSI-Rs and P CSI-RSs.

In some cases, the systems and methods described herein may be based on a reference encoder model for SPC modes. As explained, when the UE is configured for SPC, the UE may implement at least two models: a CSI prediction model and a CSI encoder model for compression. The UE may use the prediction model to predict the CSI and feed the output of prediction model to the encoder model, which compresses the predicted CSI.

In some SPC implementations, a reference encoder model may be based on inter-vendor collaboration. In some inter-vendor collaboration cases, one or more aspects of CSI encoder and/or CSI decoder models may be specified in a specification. For example, with SPC modes, specified models may be used, with configurations specified in a specification (e.g., specified number of layers, specified number of neurons, specified weights, etc.). In some cases, such specification-based reference models may be used by the UE and/or base station to train optimized prediction models, encoder models, decoder models, etc. (e.g., via offline engineering). In some cases, when an encoder model is specified in a specification, a CSI prediction model may also be specified in the specification, which may include information on the input/output dimensions, sub-band, port, and/or slot mapping to input features/output features, etc. The UE may be pre-configured with a specification-based CSI prediction model and/or with a specification-based CSI encoder model. The base station may indicate to the UE to use the specification-based CSI prediction model and/or the specification-based CSI encoder model already known to the UE.

In some inter-vendor collaboration cases, the CSI prediction model and/or the CSI encoder model may be specified. For example, one or more parameters of the CSI prediction model and/or the CSI encoder model may be exchanged between the base station and the UE. For instance, the base station may transfer to the UE the CSI prediction model and/or the CSI encoder model.

In some inter-vendor collaboration cases, exchanged data sets may include encoder data for a CSI encoder and/or prediction data for a CSI prediction model. The exchanged data may include input data type, data format, etc. Thus, instead of transferring encoder parameters to the UE, the base station may transfer model data (e.g., input data, output data, etc.) for the CSI encoder. Additionally, the base station may transfer to the UE model data (e.g., input data, output data, etc.) for the CSI prediction model. In some cases, either model may be specified by the base station. Additionally, or alternatively, either model may be a pre-selected model, a model pre-configured on the UE, a default model on the UE, etc. Accordingly, in some cases, the exchanged dataset from the base station to the UE may include input/output data for the CSI prediction model and/or the CSI encoder model.

As explained, in some SPC implementations the UE may be configured with a CSI prediction configuration that is linked to a CSI compression configuration, where the UE does not report the output of the prediction model to the base station (e.g., based on linking prediction CSI-ReportConfig to compression CSI-ReportConfig, and/or the reportQuantity of the prediction CSI-ReportConfig being set as “None”). In such cases, the UE still performs CSI-RS measurement for the prediction model. For example, the UE may still compute an estimation of the channel matrix, run an ML model to get the output of the prediction model, etc. Accordingly, the prediction CSI-ReportConfig may still counted towards CSI processing unit (CPU) occupancy time (e.g., O_CPU, where O_CPU is a fixed value from a specification or reported as UE capability). Thus, although UE does not report prediction results to the base station, computation of the prediction results may still be counted towards the CPU budget.

Also, when AI/ML inference is involved, the UE still performs inference of the prediction model. Thus, the prediction CSI-ReportConfig may be counted towards the AI/ML processing unit (APU) occupancy time (e.g., O_APU, where O_APU is a fixed value from a specification or reported as UE capability). Thus, although UE does not report prediction results to the base station, any inference computed in relation to the prediction results may still be counted towards the APU budget.

In some cases, the CPU/APU occupation window for the prediction CSI-ReportConfig may be the same as that of compression CSI-ReportConfig. For example, the time slot allocated for processing data for CSI prediction may be the same as the time slot for processing data for CSI compression. This can ensure that the UE has a consistent processing timeline for different types of AI/ML-based CSI reports.

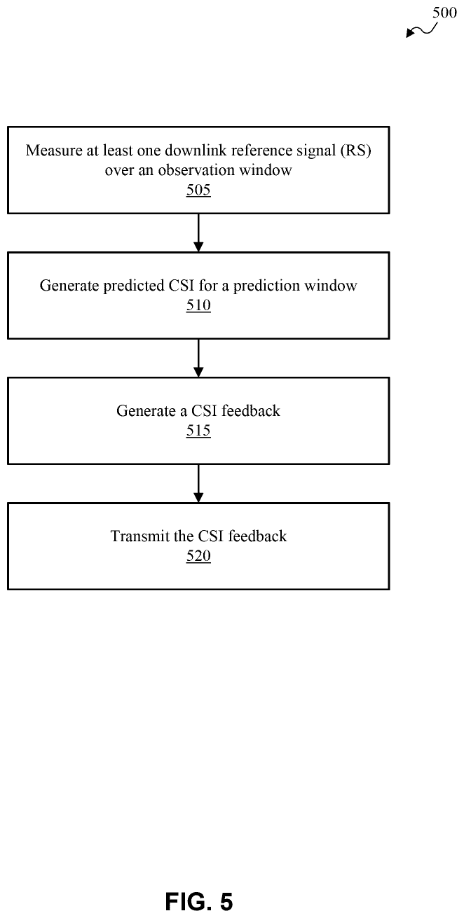

FIG. 5 depicts a flow diagram illustrating an example method 500 associated with the disclosed systems, in accordance with example implementations described herein. In some configurations, one or more aspects of method 500 may be implemented by or in conjunction with device 105, components of device 105, system 200, components of system 200, or any combination thereof. The depicted method 500 is just one implementation, and one or more operations of method 500 may be rearranged, reordered, omitted, and/or otherwise modified such that other implementations are possible and contemplated.

At 505, method 500 may include measuring at least one downlink reference signal (RS) over an observation window. For example, method 500 may include measuring at least one downlink RS over an observation window comprising a plurality of slots and sub-bands.

At 510, method 500 may include generating predicted CSI for a prediction window. For example, method 500 may include generating, using a CSI prediction model at the UE, predicted CSI for a prediction window comprising one or more future slots based at least on the measured CSI from the observation window, the UE being configured to refrain from transmitting the predicted CSI to a base station.

At 515, method 500 may include generating CSI feedback. For example, method 500 may include generating, using a CSI encoder at the UE, CSI feedback that jointly represents target CSI across time, space, and frequency for observation and prediction slots.

At 520, method 500 may include transmitting the CSI feedback. For example, method 500 may include transmitting the CSI feedback to the base station.

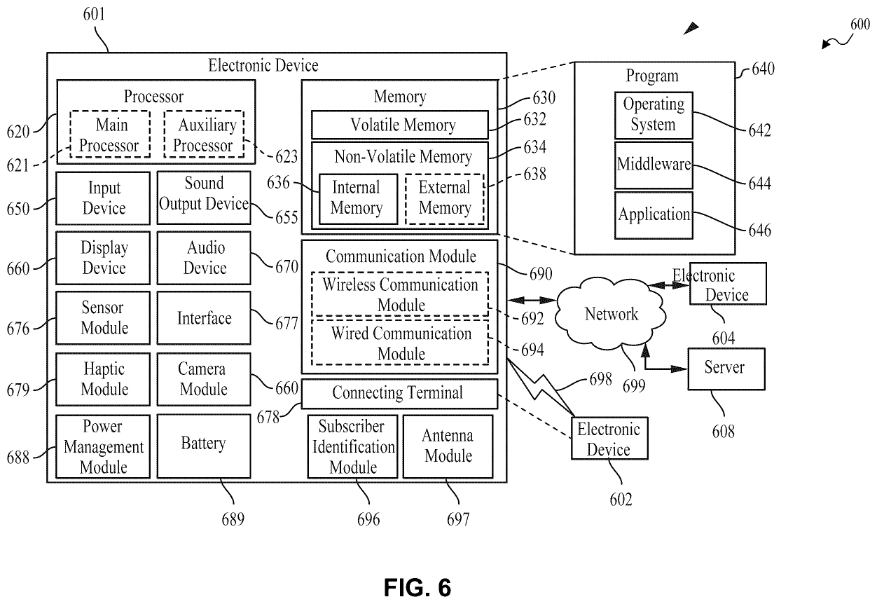

FIG. 6 depicts a block diagram of an electronic device in a network environment 600, according to embodiments described herein.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally, or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus, which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell, which is not rechargeable, a secondary cell, which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and support a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH®, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the SIM card 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of the operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

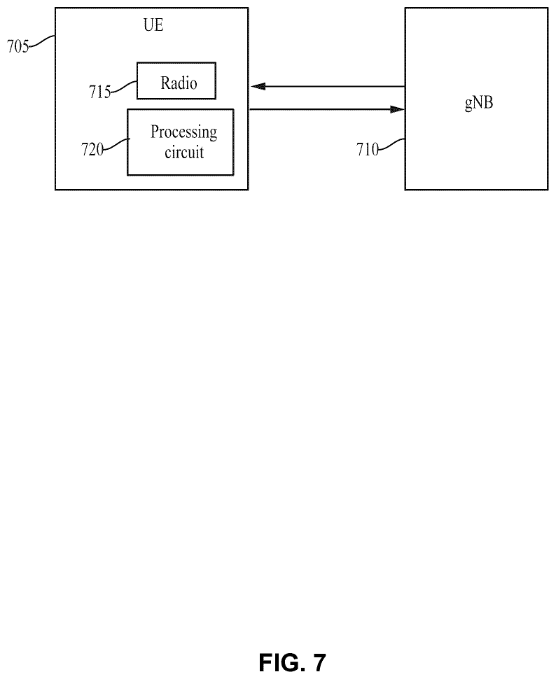

FIG. 7 shows a system including a UE 705 and a base station 710 in communication with each other. The UE may include a radio 715 and a processing circuit (or a means for processing) 720, which may perform various methods disclosed herein, e.g., the method illustrated in FIG. 1. For example, the processing circuit 720 may receive, via the radio 715, transmissions from the network node (the base station) 710, and the processing circuit 720 may transmit, via the radio 715, signals to the base station 710.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

A number of example implementations have been described. Nevertheless, it will be understood that various modifications may be made without departing from the spirit and scope of the disclosure. Accordingly, additional implementations are within the scope of the following claims. As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a user equipment (UE) for artificial intelligence/machine learning (AI/ML) based channel state information (CSI) compression, comprising:
measuring at least one downlink reference signal (RS) over an observation window comprising a plurality of slots and sub-bands;
generating, using a CSI prediction model at the UE, predicted CSI for a prediction window comprising one or more future slots based at least on the measured CSI from the observation window, the UE being configured to refrain from transmitting the predicted CSI to a base station;
generating, using a CSI encoder at the UE, CSI feedback that jointly represents target CSI across time, space, and frequency for observation and prediction slots; and
transmitting the CSI feedback to the base station.

2. The method of claim 1, wherein the UE being configured to refrain from transmitting the predicted CSI is based on:
receiving, by the UE, a first CSI configuration identifying the prediction window and a second CSI configuration identifying a compression window, wherein:
at least one of the first CSI configuration or the second CSI configuration has a report quantity field set to none to indicate refraining from reporting the predicted CSI, and
the UE uses output of the CSI prediction model as input to the CSI encoder without reporting the predicted CSI to the base station.

3. The method of claim 1, wherein the UE being configured to refrain from transmitting the predicted CSI is based on:
receiving, from the base station, an information element that indicates a first CSI configuration associated with prediction is linked to a second CSI configuration associated with compression, wherein the information element is included in the first CSI configuration, the second CSI configuration, or both.

4. The method of claim 1, further comprising:
collecting training data for the CSI encoder under a first mode in which CSI-RS for the observation window is received from the base station;
measuring target CSI for observed slots based on the CSI-RS transmitted for the observation window and not the prediction window;
obtaining, based at least in the measuring, labels for prediction slots from outputs of the CSI prediction model; and
training, based at least on the obtaining, the CSI encoder to minimize reconstruction error over target CSI spanning the observation and prediction slots.

5. The method of claim 1, further comprising:
collecting training data for the CSI encoder under a second mode, wherein CSI-RS for both the observation window and the prediction window is received from the base station under the second mode;
measuring target CSI for the observation and prediction slots; and
training, based at least on the measuring, the CSI encoder to minimize reconstruction error over measured target CSI spanning the observation and prediction slots.

6. The method of claim 1, further comprising receiving, from the base station, inter-vendor collaboration information comprising at least one of:
model parameters for the CSI prediction model and the CSI encoder model,
standardized model structures corresponding to the CSI prediction model and the CSI encoder, the standardized model comprising at least one of model version, number of layers, number of neurons, or weight values,
the CSI prediction model and the CSI encoder transmitted from the base station to the UE, or
a dataset comprising paired inputs and outputs for the CSI prediction model and paired inputs and outputs for the CSI encoder with defined time, space, frequency (TSF) mapping and quantization.

7. The method of claim 1, further comprising counting, by the UE, processing resources for the predicted CSI, including:
occupying a number of CSI processing units (CPUs), for executing the CSI prediction model for the predicted CSI;
occupying a number of AI/ML processing units (APUs) for prediction model inference performed to determine the predicted CSI; and
applying occupation window rules for a first CSI configuration that reuses occupation windows determined to be applicable to a second CSI configuration.

8. The method of claim 7, further comprising:
reporting, by the UE, capability information indicative of a maximum number of CPUs and APUs available for simultaneous CSI processing, including a dedicated capability value for prediction-only configurations linked to compression, and declining to update one or more CSI reports when configured reports exceed the reported capability.

9. The method of claim 1, further comprising:
receiving, by the UE, a CSI configuration that indicates separate prediction and compression (SPC) and specifies an observation window and a prediction window;
performing SPC according to an indicator in the CSI configuration; and
including information in the CSI feedback for a decoder of the base station to reconstruct target CSI corresponding to the prediction window.

10. The method of claim 9, further comprising:
reporting, by the UE, metrics for performance monitoring linked to a single CSI configuration, the metrics including a prediction metric indicative of prediction accuracy across one or more configured time instances and a compression metric indicative of reconstruction quality across one or more configured time instances, wherein the metrics are computed according to a decoder shared by the base station, a reference decoder, or a proxy decoder at the UE.

11. A method performed by performed a base station for artificial intelligence/machine learning (AI/ML) based channel state information (CSI) compression, comprising:
configuring a user equipment (UE) with an observation window comprising a plurality of slots and sub-bands and with a prediction window comprising one or more future slots;
transmitting at least one downlink reference signal (RS) over the observation window comprising the plurality of slots and sub-bands;
configuring the UE to use a CSI prediction model to generate predicted CSI based at least on measured CSI from the observation window and to refrain from reporting the predicted CSI;
receiving, from a CSI encoder at the UE, CSI feedback that jointly represents target CSI across time, space, and frequency for observation and prediction slots; and
reconstructing, by a decoder at the base station, target CSI for at least the observation and prediction slots based on the received CSI feedback.

12. The method of claim 11, wherein configuring the UE to refrain from reporting the predicted CSI is based on:
transmitting, to the UE, a first CSI configuration identifying the prediction window and a second CSI configuration identifying a compression window, wherein:
at least one of the first CSI configuration or the second CSI configuration has a report quantity field set to none to indicate reporting the predicted CSI is to be refrained, and
the report quantity field set to none indicates to the UE to use output of the CSI prediction model as input to the CSI encoder without reporting the predicted CSI to the base station.

13. The method of claim 11, wherein configuring the UE to refrain from reporting the predicted CSI is based on:
receiving, from the base station to indicate separate prediction and compression, an information element that indicates a first CSI configuration associated with prediction is linked to a second CSI configuration associated with compression, wherein the information element is included in the first CSI configuration, the second CSI configuration, or both.

14. The method of claim 11, further comprising:
collecting training data for the decoder under a first mode in which the base station transmits, to the UE, CSI-RS for the observation window and the base station refrains from transmitting CSI-RS for the prediction window;
transmitting, to the UE, labels for prediction slots based on outputs of the CSI prediction model; and
training, based at least on the training data, the decoder to minimize reconstruction error over target CSI spanning the observation and prediction slots.

15. The method of claim 11, further comprising:
collecting training data for the decoder under a second mode in which the base station transmits, to the UE, both the observation window and the prediction window; and
training, based at least on the training data, the decoder to minimize reconstruction error over measured target CSI spanning the observation and prediction slots.

16. The method of claim 11, further comprising transmitting, to the UE, inter-vendor collaboration information comprising at least one of:
model parameters for the CSI prediction model and the CSI encoder model,
standardized model structures corresponding to the CSI prediction model and the CSI encoder, the standardized model comprising at least one of model version, number of layers, number of neurons, or weight values,
the CSI prediction model and the CSI encoder transmitted from the base station to the UE, or
a dataset comprising paired inputs and outputs for the CSI prediction model and paired inputs and outputs for the CSI encoder with defined time, space, frequency (TSF) mapping and quantization.

17. The method of claim 11, further comprising:
obtaining, from the UE, capability information indicative of a maximum number of CSI processing units (CPUs) and AI/ML processing units (APUs) available for simultaneous CSI processing, the capability information including a dedicated capability value for prediction-only configurations linked to compression; and
scheduling CSI reporting such that configured reports do not exceed the reported capability.

18. A non-transitory computer-readable medium storing code for artificial intelligence/machine learning (AI/ML) based channel state information (CSI) compression, the computer-readable medium comprising instructions executable by one or more processors of a user equipment (UE) to:
measure at least one downlink reference signal (RS) over an observation window comprising a plurality of slots and sub-bands;
generate, using a CSI prediction model at the UE, predicted CSI for a prediction window comprising one or more future slots based at least on the measured CSI from the observation window, the UE being configured to refrain from transmitting the predicted CSI to a base station;
generate, using a CSI encoder at the UE, CSI feedback that jointly represents target CSI across time, space, and frequency for observation and prediction slots; and
transmit the CSI feedback to the base station.

19. The non-transitory computer-readable medium of claim 18, wherein:
the UE being configured to refrain from transmitting the predicted CSI is based on the UE receiving, from the base station, a first CSI configuration identifying the prediction window and a second CSI configuration identifying a compression window,
at least one of the first CSI configuration or the second CSI configuration has a report quantity field set to none to indicate the refraining from reporting the predicted CSI, and
the UE uses output of the CSI prediction model as input to the CSI encoder without reporting the predicted CSI to the base station.

20. The non-transitory computer-readable medium of claim 18, wherein:
the UE being configured to refrain from transmitting the predicted CSI is based on the UE receiving, from the base station, an information element that indicates a first CSI configuration associated with prediction is linked to a second CSI configuration associated with compression, and
the information element is included in the first CSI configuration, the second CSI configuration, or both.
